(19) United States
(12) Patent Application Publication
(10) Pub. No.: US 2026/0360054 A1
(43) Pub. Date: Nov. 12, 2026

(54) BIDIRECTIONAL IMAGE-TO-VIDEO GENERATION

(71) Applicant: Google LLC, Mountain View, CA (US)

(72) Inventors: Xinwei Yao, South San Francisco, CA (US); Weizhe Hua, Cupertino, CA (US); Ruben Eduardo Villegas, Chelsea, MI (US); Orly Liba, Palo Alto, CA (US); Mitchell Wayne McIntire, Mountain View, CA (US); Poorva Ganesh Rane, Sunnyvale, CA (US)

(21) Appl. No.: 19/202,842

(22) Filed: May 8, 2025

(51) Int. Cl. G06T 13/00; G06T 3/4046; G06T 3/4053; G06T 11/00

(52) U.S. Cl. CPC G06T 13/00; G06T 3/4046; G06T 3/4053; G06T 11/00

(57) ABSTRACT

Methods, systems, and apparatus, including computer programs encoded on a computer storage medium, for bidirectionally generating a video from a reference frame. In one aspect, a method comprises obtaining a reference video frame, generating, using a video generation neural network and conditioned on the reference video frame, a first forward segment of the video, wherein the first forward segment comprises a first number of video frames immediately following the reference video frame in the sequence of video frames, generating, using the video generation neural network and conditioned on the reference video frame, a first backward segment of the video, wherein the first backward segment comprises a second number of video frames immediately prior to the reference video frame in the sequence of video frames, and generating a first video output for inclusion in the video from the first forward segment of the video and the first backward segment of video.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate a video from a reference video frame by bidirectionally extending the video from the reference video frame in both the forward and backward directions using a video generation neural network.

In this specification, bidirectionally extending the video from the reference video frame in the forward and backward directions. In particular, extending the video in the forward direction refers to generating a forward segment of video frames immediately following the reference video frame. Relatedly, extending the video in the backward direction refers to generating a backward segment of video frames immediately prior to the reference video frame using the video generation neural network.

In particular, the system can generate “future” video frames from the reference video frame to extend in the direction of increasing time using forward update iterations and can generate “past” video frames from the reference video frame in the direction of decreasing time using backward update iterations.

According to a first aspect, there is provided a method for obtaining a reference video frame, generating, using a video generation neural network and conditioned on the reference video frame, a first forward segment of the video, wherein the first forward segment comprises a first number of video frames immediately following the reference video frame in the sequence of video frames, generating, using the video generation neural network and conditioned on the reference video frame, a first backward segment of the video, wherein the first backward segment comprises a second number of video frames immediately prior to the reference video frame in the sequence of video frames, and generating a first video output for inclusion in the video from the first forward segment of the video and the first backward segment of video.

Particular embodiments of the subject matter described in this specification can be implemented so as to realize one or more of the following advantages.

The system of this specification can generate a video from a reference video frame by conditioning on previously generated video frames to iteratively extend the video in both the forward and backward directions from the reference video frame.

Autoregressive video generation systems sequentially generate additional forward segments of video frames by conditioning on one or more video frames from the previously generated forward segment, but are limited to generating short videos with a small number of frames. As an autoregressive video generation system extends the video in the forward direction by generating additional forward segments, the frames become increasingly blurry relative to the reference video frame since each forward segment is conditioned using increasingly less clear video frames. Since the clarity decreases with each forward segment, autoregressive video generation systems are unable to generate a large number of clear frames without detrimentally impacting the video quality.

Moreover, due to the constraint imposed by conditioning the next forward segment on one or more video frames immediately preceding the next forward segment from the previously generated forward segment, autoregressive video generation systems are limited to generating a single forward segment during a time period. Since each forward update iteration provides the input used to condition the next forward update iteration, the generation of the video frames cannot be parallelized. Therefore, the latency of generating a video output using an autoregressive video generation system is high, especially for longer videos since the system is required to wait until the previous forward segment is generated before generating each next forward segment.

In contrast, the bidirectional image-to-video generation system of this specification can autoregressively extend the video in opposite directions in parallel during the same time period, thereby reducing latency required to generate the video by efficiently extending in the forward and backward directions. More specifically, the bidirectional video generation system can generate the forward and backward segments in parallel since the inputs used to condition the next forward and backward update iterations are independent. Thus, the system can reduce the amount of time required to generate the video by efficiently extending the video in both directions in parallel.

Additionally, by extending from the reference video frame in opposite directions, the system can generate an output with enhanced video fidelity relative to a forward-only video generation system. Since the video frame with the highest resolution is the reference video frame, the system is able to mitigate the gradual loss of detail and sharpness over time resulting from conditioning on increasingly less sharp video frames by decreasing the distance between the reference video frame and frames generated in each forward or backward update iteration, e.g., since the first and last video frames of the sequence of video frames in the video split the distance to the reference video frame, which is an improvement relative to the last video frame being the full distance away from the reference video frame. Thus, the system can enhance the clarity of the generated video using bidirectional video generation to mitigate the gradual loss of detail and sharpness over time resulting from conditioning on increasingly less sharp video frames.

Furthermore, the system can tailor the video generation neural network for different forward and backward video generation tasks using specialized layers that have been finetuned using curated forward and backward (reversed) video data. Beyond promoting greater motion and texture consistency, especially in the transition between the video frame immediately prior to the reference video frame and the video frame immediately following the reference video frame, the system can reduce the use of computational resources required to finetune and deploy the video generation neural network for use in the forward and backward update iterations since the layers are modularized.

More specifically, by implementing the video generation neural network with specialized layers, the system, or a training system, can determine the values of the parameters for forward and backward generation by updating only the subset of values of the neural network in the specialized layers, thereby reducing the use of computation resources relative to finetuning the entire set of parameter values of the neural network. Moreover, by supplementing a base video generation neural network with either a specialized forward or backward generation layer, the system can decrease the number of parameter values that need to be stored in computational memory during deployment. That is, rather than storing two separate forward and backward video generation neural networks for separate use in the forward and backward update iterations, the system can adapt a base video generation neural network for both forward and backward video generation using the specialized layers.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 provides an overview of bidirectional image-to-video generation.

FIG. 2 is a system diagram of an example bidirectional image-to-video system.

FIG. 3 illustrates the difference in clarity between a video frame generated using a forward-only generation image-to-video system and a video frame generated using a bidirectional image-to-video system.

FIG. 4 depicts an example preference comparison between video outputs generated using a forward generation image-to-video system and a bidirectional image-to-video system.

FIG. 5 is a flow diagram of an example process for generating a video using bidirectional image-to-video generation.

Like reference numbers and designations in the various drawings indicate like elements.

### DETAILED DESCRIPTION

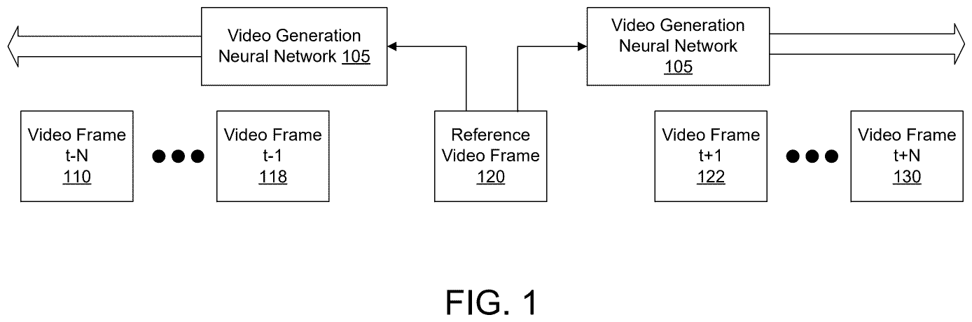

FIG. 1 provides an overview of bidirectional image-to-video generation. In particular, FIG. 1 demonstrates how a reference video frame 120 can be bidirectionally extended along both a forward and backward direction, using a video generation neural network 105.

More specifically, each video frame in the sequence of video frames in the video can be associated with a temporal ordering, e.g., the reference video frame 120 can be associated with a particular time step t and a bidirectional image-to-video system can bidirectionally extend from time step t to both the “future” and the “past” video frames with respect to time step t. That is, each video frame in the sequence of the video frames is associated with a corresponding time step and the time steps increase in the order of the sequence, so that later video frames in the sequence have larger time steps than earlier frames in the sequence.

In this context, the system can generate video frames at later time steps than the reference video frame by generating one or more forward segments of the video, and the system can generate video frames at earlier time steps than the reference video frame by generating one or more backward segments of the video. In particular, the system can bidirectionally extend the video from the reference video frame in the forward and backward directions by generating one or more forward segments of video frames immediately following the reference video frame with time steps greater than t, e.g., resulting video frames with time steps t+1, t+2, t+3, etc., and one or more backward segments of video frames immediately prior to the reference video frame with time steps less than t, e.g., resulting video frames with time steps t−1, t−2, t−3, etc., using the video generation neural network 105.

In the particular example depicted, the bidirectional image-to-video generation system can bidirectionally extend the number of video frames in the forward and backward directions from the reference video frame 120 by generating one or more forward segments of video frames immediately following the reference video frame 120, e.g., resulting in the video frames associated with time steps t+1 122 to t+N 130, and one or more backward segments of video frames immediately prior to the reference video frame 120, e.g., resulting in the video frames associated with time steps t−1 118 to t−N 110, using the video generation neural network 105. For example, the system can generate from t+1 to t+N using one or more forward update iterations, and from t−1 to t−N using one or more backward update iterations.

In contrast to a forward-only generation image-to-video system, which is limited to generating a single forward segment at a time since each forward update iteration provides the input used to condition the next forward update iteration, the bidirectional video generation system can reduce the latency required to generate the video by efficiently generating the forward and backward segments in parallel since the inputs used to condition the next forward and backward update iterations are independent.

While depicted here with the resulting video including the same number of “past” video frames as “future” video frames, e.g., from t−N to t+N, the bidirectional image-to-video system can generate any number of “past” and “future” frames. As an example, as shown in FIG. 1, the system can perform symmetrical extension by generating the same number of forward and backward update iterations with the same number of video frames being generated in each forward and backward update iteration using the video generation neural network 105. As another example, the system can perform asymmetrical extension by generating a different number of “past” and “future” frames from a different number of forward and backward update iterations, or by generating a different number of frames in each forward and backward update iteration.

The video generation neural network 105 can have any appropriate neural network architecture that can be configured to process one or more conditioning images as a conditioning input to generate one or more images immediately following or immediately prior to the conditioning images. For instance, the video generation neural network 105 can have any appropriate number of neural network layers (e.g., 20 layers, 50 layers, or 100 layers) of any appropriate type (e.g., fully-connected layers, attention layers, convolutional layers, etc.) connected in any appropriate configuration (e.g., as a linear sequence of layers, or as a directed graph of layers).

In this case, the conditioning input provides extra data to the video generation neural network 105 to guide the generation of the video frame output. Since the bidirectional image-to-video system is extending in two different directions, the system can align the conditioning input with the direction of generation. That is, the bidirectional video generation system can process a forward conditioning input including previously generated video frames in the order of increasing time when generating in the forward direction, and can process a reversed conditioning input including previously generated video frames in the order of decreasing time when generating in the backward direction.

For example, the system can generate the forward segment starting with video frame t+1 122 by conditioning on the reference video frame 120, extend to video frame t+2 by conditioning on the reference video frame 120 and video frame t+1 122, extend to video frame t+3 by conditioning on the reference video frame 120, video frame t+1 122, and video frame t+2, and so on, while maintaining the temporal ordering. In contrast, the system can generate the backward segment starting with video frame t−1 118 by conditioning on the reference video frame 120, extend to video frame t−2 by conditioning on the reference video frame 120 and video frame t−1 118, extend to video frame t−3 by conditioning on the reference video frame 120, extend to video frame t−1 118, and video frame t−2, and so on, while maintaining the reversed temporal ordering.

While described above as conditioning with the previously generated frames, the conditioning input can include any number of conditioning video frames. In some cases, the conditioning input is limited to N previously generated video frames, e.g., where N is three, five, or ten. As another example, the system can generate the backward segment starting with video frame t−1 118 to t−5 by conditioning on the reference video frame 120, extend to video frame t−10 by conditioning on video frame t−1 118 to t−5, extend to video frame t−15 by conditioning on video frame t−5 to t−10, and so on, while maintaining the reversed temporal ordering.

Since the generation is bidirectional from time t, the bidirectional image-to-video system can generate the forward and backward segments in parallel, e.g., the system can generate from t+1 122 to t+N 130 while generating from t−1 118 to t−N 110. More specifically, in contrast to a forward-only generation image-to-video system, which is limited to generate a single forward segment during the same time period since each forward update provides the conditioning input for the next forward update, the bidirectional video generation system can generate the forward and backward segments in parallel, thereby reducing the amount of time required to generate the video by efficiently extending the video in both directions. In particular, the system can extend the video in parallel in both the forward and backward direction at the same time since the conditioning inputs for the forward and backward directions are independent.

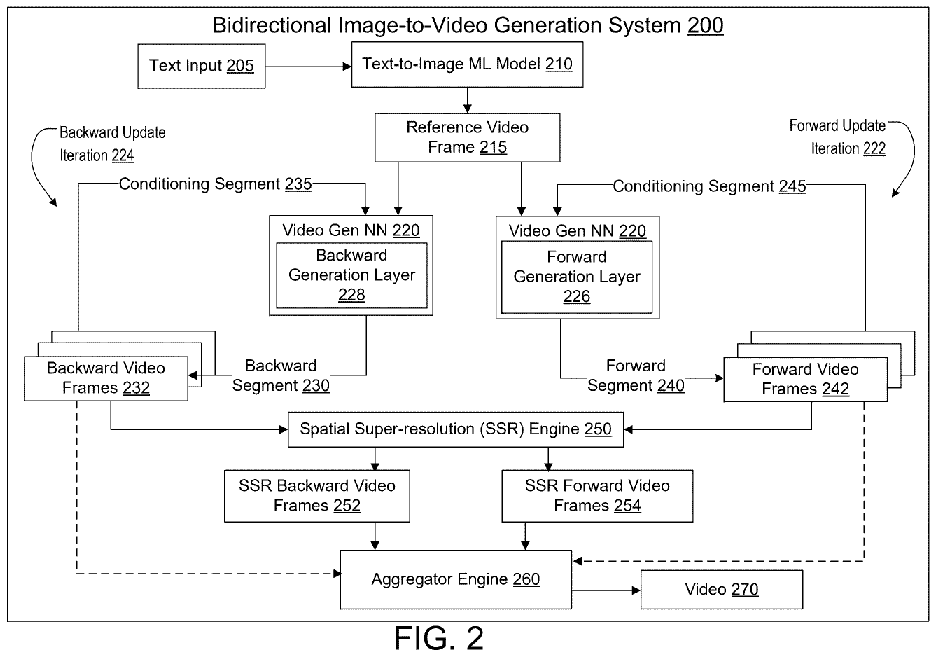

FIG. 2 shows a bidirectional image-to-video system 200. The bidirectional image-to-video system 200 is an example of a system implemented as computer programs on one or more computers in one or more locations in which the systems, components, and techniques described below are implemented.

The bidirectional image-to-video generation system 200 can be used to generate a video including a sequence of video frames by extending a reference video frame 215 in both a forward and backward direction, e.g., as is described in FIG. 1. For example, the bidirectional image-to-video system 200 can generate the video frames t−1 118 to t−N 110 in the backward direction and t+1 122 to t+N 130 from the reference video frame 120 in FIG. 1 in parallel using one or more forward and backward update iterations, as is described in more detail below.

In some cases, the system 200 can obtain the reference video frame 215, e.g., from a user or as an input from another system. In other cases, the system 200 can generate the reference video frame 215. In the particular example depicted, the system 200 can receive a text input 205. In this case, the text input 205 can include a prompt, e.g., a directive instruction, to generate a video according to details in the prompt. As an example, the text input 205 can include a prompt to generate a video of “A fishmonger fillets fish in the market”, “Dog chases squirrel in field”, or “A fish swims in the ocean”.

The system 200 can process the text input 205 using a text-to-image machine learning model 210 to generate the reference video frame 215. In particular, the system 200 can generate the reference video frame 215 based on the details included in the prompt, e.g., since the reference video frame 215 serves as the foundation of the video by providing a starting point for both forward and backward generation.

The text-to-image machine learning model 210 can have any appropriate neural network architecture that can be configured to process a text input 205 and generate an image, e.g., the reference video frame 215. In particular, the text-to-image machine learning model 210 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the text-to-image machine learning model 210 can be a generative machine learning model, e.g., a transformer-based model, a text-to-image generative-adversarial network (GAN), or a diffusion neural network. In the case the text-to-image machine learning model 210 is a text-to-image GAN, the model 210 can generate an embedding from the text input 205 and use the embedding to condition the output of the generator and to inform the discriminator. In the case the text-to-image machine learning model 210 is a diffusion neural network, the model 210 can be configured to sequentially refine an initial state of noise through a sequence of transformations that reduce the noise by conditioning on the text input 205 to generate the reference video frame 215.

As an example, the text-to-image machine learning model 210 can be implemented as a latent diffusion model that includes an encoder block to map images to a lower-dimensional latent space before applying the sequence of transformations and a decoder block to map from the lower-dimensional latent space back into image space. As a particular example of this, the model 210 can be implemented as a U-Net that includes skip connections that allow the model 210 to combine both coarse features from the beginning of the sequence of transformations and fine features from the end of the sequence of transformations to improve the generated image quality.

The system 200 can process the reference video frame 215 using a video generation neural network 230. As described with respect to FIG. 1, the system 200 can use the video generation neural network 220 to generate in a forward direction, e.g., the forward generation 222, and in a backward direction, e.g., the backward direction 224. More specifically, the system 200 can generate one or more “future” video frames in the sequence of video frames in the video by generating forward segments in each forward update iteration 222, and can generate one or more “past” video frames in the sequence of video frames by generating backward segments in each backward update iteration 224.

In particular, the video generation neural network 230 can be any kind of auto-regressive neural network that generates each video frame conditioned on one or more video frames that precede the video frame in the video according to a particular order, e.g., a temporal order or a reverse temporal order. As an example, the video generation neural network 230 can be implemented as a video encoder neural network, a token generation neural network, and a video decoder neural network, e.g., as described in WIPO PCT App. No. PCT/US23/34037, which is incorporated herein by reference. As another example, the video generation neural network 230 can be implemented as VideoGPT, e.g., as is described in Yan, et. al. “VideoGPT: Video Generation using VQ-VAE and Transformers” (2021, arXiv:2104.10157v2).

As described with respect to FIG. 1, at each backward update iteration, the system 200 can use the video generation neural network 220 to process one or more immediately following video frames of the previously generated backward segment 230 as a conditioning segment 235 to generate a next backward segment 230 to be included in the backward video frames 232 prior to the reference video frame 215. In this context, the one or more immediately following video frames refer to video frames following the next generated video frame in the next backward segment 240.

More specifically, in the first backward update iteration, the system 200 can process the reference video frame 215 using the video generation neural network 220 to generate N video frames immediately prior to the reference video frame 215 as the first backward segment. In the second backward update iteration, the system 200 can then process one or more immediately following videoframes included in the first backward segment as the conditioning segment 235 using the video generation neural network 220 to generate X video frames as the preceding backward segment immediately prior to the first backward segment. Then, in the third backward update iteration, the system 200 can process one or more immediately following video frames included in the preceding backward segment as the conditioning segment 235 using the video generation neural network 220 to generate X video frames as the additional preceding backward segment immediately prior to the preceding backward segment, and so on. Thus, the system 200 can extend the reference video frame 215 in the backward direction by generating previous video frames in the sequence of video frames by conditioning on previously generated backward segments.

In this context, N and X are specific numbers determined based on constraints of the video generation neural network 220. For example, in the case that the video generation neural network 220 is a token generation neural network, the token generation neural network is constrained to processing and outputting a certain number of tokens, e.g., T total tokens for the input and output tokens in each backward update iteration 224.

In some cases, the number of conditioning video frames in the conditioning segment 235 remains static throughout the backward update iterations. In other cases, the system can modify the number of conditioning video frames in the conditioning segment 235, e.g., based on the number of elapsed backward update iterations.

As an example, in the case that T tokens corresponds with 11 total video frames, the system 200 can generate 10 video frames in the first backward segment, e.g., since the sum of the reference video frame 215 and the 10 video frames is 11 frames, and the system 200 can generate T-C video frames in each additional backward segment, where C is the number of video frames in the conditioning segment 235. For example, in the case that C is 5 video frames, the system 200 can generate 6 video frames in each additional backward segment. As another example, in the case that C is 3 video frames, the system 200 can generate 8 video frames in the next backward segment.

In particular, the system can provide more context by including more than one frame in the conditioning input, the video generation neural network to improve the quality of the generated video. By including multiple frames, the system can improve temporal coherence of evolving motion between frames by providing more information regarding object trajectories over time, higher-level dynamics, e.g., periodic motion, increasing/decreasing motion, cause and effect, and relations between objects.

Likewise, as described with respect to FIG. 1, the system 200 can use the video generation neural network 220 to generate a next forward segment by conditioning on previously generated forward segments. At each forward update iteration, the system 200 can use the video generation neural network 220 to process one or more immediately preceding video frames of the previously generated forward segment 230 as a conditioning segment 245 to generate a next forward segment 240 to be included in the forward video frames 242 following the reference video frame 215. In this context, the one or more immediately preceding video frames refer to video frames directly prior to the next generated video frame in the next forward segment 240.

More specifically, in the first forward update iteration, the system 200 can process the reference video frame 215 using the video generation neural network 220 to generate M video frames immediately following the reference video frame 215 as the first forward segment. In the second forward update iteration, the system 200 can then process one or more immediately preceding frames included in the first forward segment as the conditioning segment 245 using the video generation neural network 220 to generate Y video frames as the next forward segment immediately following the first forward segment. Then, in the third forward update iteration, the system 200 can process one or more immediately preceding frames included in the next forward segment as the conditioning segment 245 using the video generation neural network 220 to generate Y of video frames as the additional next forward segment immediately following the next forward segment, and so on. Thus, the system 200 can extend the reference video frame 215 in the forward direction by generating subsequent frames in the sequence of video frames by conditioning on previously generated forward segments.

In this context, the M and Y are specific numbers determined based on constraints of the video generation neural network 220. For example, in the case that the video generation neural network 220 is a token generation neural network, the token generation neural network is constrained to processing and outputting a certain number of tokens, e.g., T total tokens for the input and output tokens in each forward update iteration 224.

Similarly to the backward update iterations, in some cases, the number of conditioning video frames in the conditioning segment 235 remains static throughout the forward update iterations. In other cases, the system can modify the number of conditioning video frames in the conditioning segment 235, e.g., based on the number of elapsed forward update iterations.

As an example, in the case that T relates to 11 total video frames, the system 200 can generate 10 video frames in the first forward segment, e.g., since the sum of the reference video frame 215 and the 10 video frames is 11 frames, and the system 200 can generate T-C video frames in each additional forward segment, where C is the number of video frames in the conditioning segment 245. For example, in the case that C is 5 video frames, the system 200 can generate 6 video frames in each additional forward segment. As another example, in the case that C is 3 video frames, the system 200 can generate 8 video frames in the next forward segment.

While described above in terms of M video frames in the first backward and N video frames in the first forward segment and a different number of video frames in each additional backward and forward segment, e.g., X and Y respectively, M and N and X and Y are not required to be the same numbers. That is, the system 200 is not constrained to generate symmetric video frames in both the forward and backward direction.

As an example, the system 200 can generate a greater number of backward video frames 232 than forward video frames 242 by performing a greater number of backward update iterations 224 than forward update iterations 222, or by including fewer conditioning frames in the backward conditioning segment 235 than the forward conditioning segment 245. As another example, the system 200 can generate more forward video frames 232 than backward video frames 242 by performing more forward update iterations 222 than backward video iterations 224, or by including fewer conditioning frames in the forward conditioning segment 245 than the backward conditioning segment 235. As yet another example, the system 200 can generate an unequal number of forward 242 and backward 232 video frames by using a different video generation neural network for the forward and backward update iterations, e.g., with a different total token generation constraint.

Regardless of whether the generation is symmetric or asymmetric, the bidirectional system 200 can generate the forward and backward segments in parallel, e.g., the system 200 can perform each backward update iteration 224 during the same time period as each forward update iteration 222, since the backward conditioning segment 235 is independent of the forward conditioning segment 245. In particular, the system can deploy one instance of the video generation neural network 220 for forward generation on one set of parallel processing hardware, e.g., artificial intelligence (AI) accelerator hardware (TPUs, GPUs, etc.), and another instance of the video generation neural network 220 for backward generation on a separate set of AI accelerator hardware. The system can then run each forward and backward update iteration in parallel, thereby allowing the system can reduce the latency of generating the sequence of video frames in the video 270 by half relative to a forward-only generation system that relies on generating the conditioning segment 245 for the next forward update iteration by completing the previous forward update iteration 222.

In the particular example depicted, the system 200 can use the same video generation neural network 220 for both forward and backward update iterations, e.g., by deploying separate instances of the video generation neural network 220 for both forward and backward update iterations on different AI accelerator hardware.

The system 200 can specialize the video generation neural network 220 for forward motion generation and backward motion generation. Generally, motion in the direction of increasing time can be understood as observations drawn from a forward motion data distribution, while motion in the direction of decreasing time, can be understood as observations drawn from a backward motion data distribution, e.g., including forward motion that has been reversed.

Since the two motion distributions are different, the system 200 can implement the video generation neural network 220 using one or more specialized layers for forward and backward generation, respectively. In some cases, the system 200 can use the same video generation neural network 220 with particular layers specialized for each direction of generation, e.g., a backward generation layer 228 for extending in the backward direction and a forward generation layer 226 for extending in the forward direction. In other cases, the system 200 can use a video generation neural network 220 configured for forward video generation and implement a specialized backward generation layer 228 for backward video generation.

In another case, the system 200 can implement the video generation neural network 220 with multiple specialized layers, e.g., for a variety of forward and backward generation tasks. For example, the system 200 can use a forward video animation layer to generate the first forward segment, and the system 200 can use a backward video animation layer to generate the first backward segment. As another example, the system 200 can use a forward video extension layer to generate additional forward segments, and the system 200 can use a forward extension layer to generate additional backward segments.

As an example, the specialized layers 226 and 228 can include one or more of self-attention layers of each of the transformers of the model described in WIPO PCT App. No. PCT/US23/34037. In this context, each of the specialized layers 226 and 228 can have been trained using forward or backward video data, respectively. As an example, the backward video data can include forward video data that has been temporally reversed.

For example, the system 200, or another training system, can determine the parameter values of the specialized forward generation layer 226 and the specialized backward generation layer 228 by performing a low-rank approximation of the update needed to modify a baseline layer into each respective layer 226 and 228. In this case, performing a low-rank approximation refers to decomposing a matrix containing the baseline parameter values of the baseline layer, e.g., a product of two smaller matrices that when multiplied together can recover the parameter values of the baseline layer with high fidelity. The system 200 can then determine the change in the baseline layer by updating the values of the two smaller matrices of the low-rank decomposition using either forward or backward video data.

In particular, the system 200, or another training system, can approximate the change in the parameter values of a baseline layer W_0 as W_0+ΔW≈W_0+BA, where BA approximates the change in parameter values between the baseline layer and the specialized layer 226 and 228. In this case, the rank of a matrix refers to the number of linearly independent vectors, e.g., the sum of columns or rows within the matrix decomposition BA that do not contain correlative data. The rank determined specifies the dimensionality of ΔW needed by providing a constraint on the dimensions of the two smaller matrices. For example, in the case in which B is a matrix of dimension d×r and A has dimension r×k, where r must be the same to enable the matrix multiplication, the rank r can be a value much less than the minimum of d and k, e.g., r«min(d, k).

In some cases, the system 200 can determine the backward generation layer 228 using the forward generation layer 226. In particular, the forward generation layer 226 can be a baseline layer of a pretrained video generation neural network 220 that has been trained using forward video data and the system 200 can determine the parameter values of the backward generation layer 228 by freezing every layer besides the forward generation layer 228 and finetuning the forward generation layer 228 using backward generation data to determine the parameter values of the backward generation layer 226.

In the particular example depicted, the system 200 can implement the video generation neural network 220 with a backward generation layer 228 that was determined using a low-rank approximation, as described above. In other examples, the system 200 can implement the video generation neural network 220 with a backward generation layer 228 that was determined by finetuning the entire forward generation layer 226, e.g., as opposed to determining the approximation to the parameter change ΔW=BA.

In the case that the system 200 specializes multiple forward and backward layers for a variety of forward and backward generation tasks, the parameters of each specialized layer can have been determined using a corresponding dataset for the particular forward or backward animation task. As an example, the forward animation dataset can include data for animating tasks that relate to generating movement from the reference video frame 215 in the direction of increasing time. Similarly, the backward animation dataset can include data for animating tasks that relate to generating backward movement from the reference video frame 215 in the direction of decreasing time. As another example, the forward extension dataset can include data for extension tasks that relate to maintaining movement in subsequent frames, and the backward extension dataset can include data for extension tasks that relate to maintaining movement in prior frames.

By generating the video 270 using specialized layers, the system 200 can achieve greater synchronization of the forward and backward segments of the video 210 by ensuring the motion in the direction of increasing and decreasing time are consistent. In particular, in the case the specialized backward generation layer 228 is finetuned using reversed forward video data, the video frames generated in the backward segments will flow naturally into the video frames generated in the forward video segments.

In some cases, after the conclusion of the forward 222 and backward 224 update iterations, the system 200 can process the forward video frames 242 and the backward video frames 244 using a spatial super-resolution (SSR) engine 250 to generate super-resolution video frames for the video 270, e.g., the SSR backward video frames 252 and the SSR forward video frames 254. For example, the spatial SSR engine 250 can be implemented using a non-autoregressive video transformer with windowed-local attention along each of a temporal, spatial vertical, and spatial horizontal axis to increase video resolution within the video frames in order to generate a super-resolution video frame output.

As an example, the SSR engine 250 can process either the forward 242 or backward 244 video frames to generate a sequence of high-resolution outputs by embedding the video frames 242 or 244, or using the token embedding outputs from the video generation neural network 220, initializing a set of high-resolution video frame token embeddings, and using windowed local-attention to update values of the initial set of high resolution token embeddings to generate the output set of high-resolution token embeddings that can be decoded as the high-resolution video output.

In this case, the SSR engine 250 can use a multi-axis transformer block to employ the windowed local-attention mechanism, e.g., by including one transformer layer for each axis along which attention is performed. For example, the multi-axis transformer block can employ three transformer layers to perform self-attention using a local window aligned with temporal, spatial horizontal, and spatial vertical axes. In some cases, the size of the window, e.g., the size of the attention-window for each axis, can be predetermined. In other cases, the size of the window can be dynamically determined, e.g., based on the relative position of the low-resolution token in the overall sequence of video frames. In particular, the engine 250 can cross-attend the high-resolution tokens with the low-resolution tokens along each of the temporal, spatial horizontal, and spatial vertical axes, and can also self-attend the high-resolution tokens.

The system 200 can process the video frames using the SSR engine 250 according to the temporal ordering of the generation of the video frames in the forward and backward directions relative to the reference video frame 215. More specifically, the system 200 can process the forward video frames 244 in the order of increasing time and the backward video frames 242 in the order of decreasing time to provide the reference video frame 215 as the first input to the SSR engine 250.

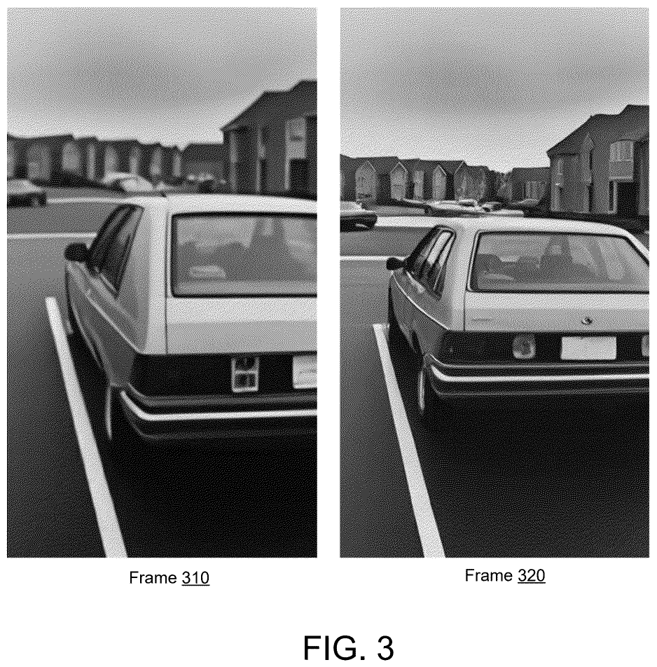

In more detail, the video frame with the highest resolution is the reference video frame 215, because the farther away from the video reference video frame 215 a generated video frame is, the more likely the video frame is to be blurry due to having been conditioned on increasingly less sharp generated video frames. Therefore, by generating the super-resolution images 252 and 254 from the reference video frame 215 in opposite directions, the system 200 is able to mitigate the gradual loss of detail and sharpness over time resulting from condition on increasingly less sharp video frames, thereby enhancing the clarity of the generated output, e.g., as is depicted in FIG. 3.

In particular, the system 200 can process the backward video frames 232 in a reverse temporal order (in the direction of decreasing time) to generate the SSR backward video frames 252 as output, e.g., the system 200 can process reference video frame 215 at time t, video frame t−1, video frame t−2 . . . video frame t−N using the SSR engine 250 to generate the SSR backward video frames 252. In contrast, the system 200 can process the forward video frames 242 in an increasing temporal order to generate the SSR forward video frames 254 as output, e.g., the system 200 can process reference video frame 215 at time t, video frame t+1, video frame t+2, . . . video frame t+N using the SSR engine 250 to generate the SSR forward video frames 254.

The system 200 can then use an aggregator engine 260 to aggregate the high-resolution SSR backward video frames 252 and the SSR forward video frames 254 into the sequence of video frames in the video 270, e.g., by reordering and assembling the high-resolution video frames according to the increasing temporal order. In particular, the aggregator engine 260 can reorder the SSR backward video frames 252 by reversing the order of SSR backward video frames 252, such that the engine 260 can append the SSR backward video frames 252 to the forward video frames 254, e.g., in the temporal order of video frame t−N, . . . video frame t−2, video frame t−1, reference video frame 215, video frame t+1, video frame t+2, . . . to video frame t+N.

While described above as generating a video 270 with high resolution using the spatial SSR engine 260, in some cases, the system 200 can output a video 270 at the resolution generated by the video generation neural network 220. In this case, the system 200 can bypass the spatial SSR engine 260 to directly process the backward video frames 232 and the forward video frames 242 using the aggregator engine 260, e.g., by reordering and assembling the generated video frames from the video generation neural network according to the increasing temporal order as described above.

Moreover, the system 200 can correct for any glitch in the transition between the first video frame immediately following the reference video frame 215 and the first video frame immediately prior to the reference video frame 215 by removing the reference video frame 215 from the sequence of video frames in the video 270, e.g., after aggregating. In particular, since the reference video frame 215 is not generated using the video generation neural network 220, the reference video frame 215 does not necessarily fit with the sequence of video frames generated in the forward and backward segments. Generally, the reference video frame 215 is likely to have a different resolution than the video frames in the forward and backward segments, e.g., as the reference video frame is either a real image obtained by the system 200 or an image generated using the text-to-image video generation neural network 210.

After aggregating using the aggregator engine 260, the system 200 can provide the video 270 as output, e.g., to a user. For example, the bidirectional image-to-video generation system can perform text-to-video synthesis to create high-quality animations tailored to text inputs. As another example, the system 200 can be used to dynamically generate scenes and create environments, e.g., to build a world in video game, As yet another example, the system 200 can be used to generate training data for a neural network, e.g., by generating observation data for a particular task performed by a robot, by generating visual data for action recognition or scene understanding tasks, or by generating data that can be used to perform multimodal alignment.

FIG. 3 illustrates the difference in clarity between a video frame generated using a forward generation image-to-video system and a video frame generated using a bidirectional image-to-video system, e.g., the bidirectional image-to-video system 200 of FIG. 2.

In this case, the forward generation image-to-video system refers to a system that autoregressively generates forward segments based on previously generated forward segments. Since the forward generation system relies on previously generated forward segments, the system 200 generates video frames that are increasingly removed from the reference video frame. As discussed with respect to FIG. 2, the farther away a generated video frame is from the video reference video frame, the more likely the video frame is to be blurry due to being conditioned on increasingly less sharp generated video frames. Moreover, by repeatedly conditioning on increasingly less sharp images, the overall texture becomes inconsistent over time.

In contrast, the bidirectional image-to-video system can mitigate the loss in detail by effectively decreasing the distance between the reference video frame and the generated video frame, e.g., since the system is conditioning on less blurry video frames as forward and backward updates originate at the reference video frame. For example, in the case that the bidirectional image-to-video system is generating symmetric forward and backward segments, the reference video frame will be the median frame in the sequence of video frames, effectively halving the distance between the reference video frame and generated video frames in either the forward or backward directions. Thus, the bidirectional image-to-video generation can mitigate the loss of video fidelity resulting from conditioning the video generation on video frames farther from the reference video frame.

In the particular example depicted, frame 320 and 310 were both generated for a text input including the directive to generate a video of “a car pulling up to a parking space in a suburb in the 1980s”. In this case, frame 320 was generated by a bidirectional image-to-video system, and is noticeably more sharp and detailed than the frame 310, which was generated using a forward image-to-video system.

In particular, the frame 320 has more pronounced texture than the frame 310. While the difference in detail in the foreground is evident based on the sharpness of the lines of the car as it approaches the parking spot, the difference is even more pronounced in the background, e.g., the houses are extremely blurred and the texture is flattened in 310, while the houses remain sufficiently clear and three-dimensional in frame 320. The difference in clarity is a direct result in the different conditioning approaches described above, e.g., by conditioning on relatively sharper images than the forward-only generation approach, the bidirectional image-to-video system is able to generate video frames that are noticeably clearer than the forward-only image-to-video system.

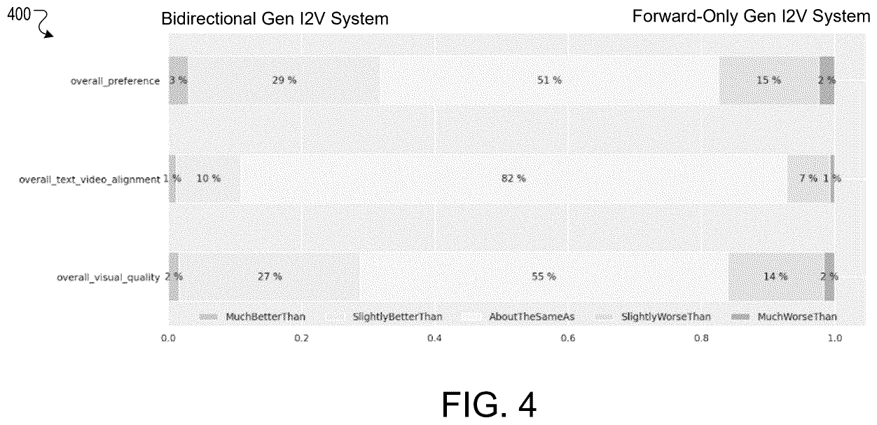

FIG. 4 depicts an example preference comparison between video outputs generated using a forward-only generation image-to-video (I2V) system and a bidirectional image-to-video (I2V) system. In this case, both systems generated the reference video frame using a generative model before performing bidirectional and forward-only generation, respectively.

In particular, the graph 400 demonstrates results from presenting a set of videos generated by processing 450 prompts using a forward-only I2V system and a bidirectional I2V system to a number of human reviewers. In the particular example depicted, the corresponding videos generated by both the forward-only and bidirectional systems for each prompt were viewed by three reviewers, who were asked to state their preferences regarding which video they preferred, the prompt to video alignment in each video, and the visual quality of each video.

The graph 400 includes aggregated results demonstrating that human reviewers have a preference for video generated using the bidirectional I2V system. While the majority of reviewers found a similar level of alignment between the text prompt and the video using both the forward and bidirectional generation approaches, thereby confirming that both approaches generated relevant videos for given text prompts, approximately 30% of reviewers found that the overall visual quality was improved relative to the forward generation approach.

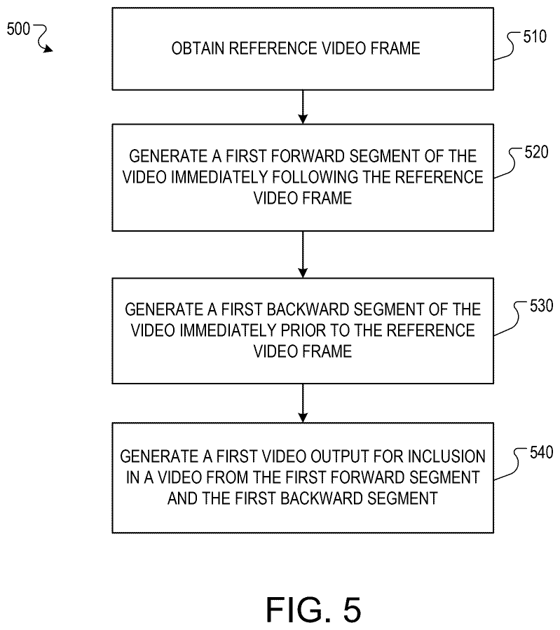

FIG. 5 is a flow diagram of an example process for generating a video including a sequence of video frames using bidirectional image-to-video generation. For convenience, the process 500 will be described as being performed by a system of one or more computers located in one or more locations. For example, a bidirectional image-to-video generation system, e.g., the bidirectional image-to-video generation system 200 of FIG. 2, appropriately programmed in accordance with this specification, can perform the process 500.

The system can obtain a reference video frame (step 510). As an example, the system can receive the reference video frame, e.g., as an input from a user or another system. As another example, the system can receive a text prompt and can generate the reference video frame by processing the text prompt using a text-to-image machine learning model.

The system can generate a first forward segment of the video immediately following the refence video frame (step 520). In particular, the system can generate, using a video generation neural network and conditioned on the reference video frame, a first number of video frames, e.g., N video frames, immediately following the reference video frame in the sequence of video frames as the first forward segment.

The system can generate a first backward segment of the video immediately prior to the reference video frame (step 530). In particular, the system can generate, using a video generation neural network and conditioned on the reference video frame, a second number of video frames, e.g., M video frames, immediately prior to the reference video frame in the sequence of video frames.

In some cases, the system can use the same video generation neural network for both forward and backward generation. In this case, the first number of video frames and the second number of video frames are equivalent, e.g., M=N. For example, the video generation neural network can be an auto-regressive neural network that generates each video frame conditioned on one or more previously generated video frames according to a temporal ordering of the sequence of video frames within the video.

In particular, the system can generate each video frame in the first forward segment by conditioning the video generation neural network on the reference video frame and any already-generated video frames within the first forward segment that precede the video frame in the temporal order. In this case, the system can generate the forward segments in the direction of increasing time by conditioning on past frames, e.g., each additional forward segment is generated using video frames immediately preceding the additional forward segment.

Likewise, the system can generate each video frame in the first backward segment by conditioning the video generation neural network on the reference video frame and any already-generated video frames within the first backward segment that follow the video frame in the video frame in the temporal ordering. In this case, the system can generate the backward segments in the direction of decreasing time by conditioning on future frames, e.g., each additional backward segment is generated using video frames immediately following the additional backward segment.

As an example, the system can generate the first forward segment of the video using the video generation neural network with a first set of parameter values, and the first backward segment of the video using the video generation neural network with a second set of parameter values. In particular, the second set of parameter values can have been finetuned for backward video generation on a dataset including reversed video extension data, or reversed video animation data, or both. For example, the second set of parameter values can include the first set of parameters and parameter values from one or more low-rank adaptation (LoRA) layers.

The system can then generate a first video output for inclusion in the video from the first forward segment and the first backward segment (step 540). For example, each video frame in the sequence of video frames can be associated with a respective time step in a temporal ordering. In this case, the system can generate the first video output by combining the video frames of the first backward segment and the first forward segment according to the temporal ordering of the time steps within the video. In some cases, the reference video frame is not included in the first video output.

In some cases, the system can upsample the first video output, e.g., the first video output can have a first spatial resolution, and the system can generate a second output video that has a second higher spatial resolution using the reference video frame and each of the video frames of the first video output. In particular, in the case that each video frame in the sequence of video frames can be associated with a respective time step in a temporal ordering, the system can process (i) the reference video frame and the first backward segment, and (ii) the reference video frame and the first forward segment according to the temporal argument.

For example, the system can process, from the reference video frame to a first video frame of the first backward segment according to the temporal order, using a spatial super-resolution model, to generate super-resolution video frames for the first backward segment. As another example, the system can process, from the reference video frame to a last video frame of the first forward segment according to the temporal order, using the spatial super-resolution model to generate super-resolution video frames for the forward segment.

Furthermore, in some cases, the system can generate additional forward segments, additional backward segments, or both for inclusion in the video. In this case, the system can generate the video from the first video output and the one or more additional forward, additional backward, or both segments.

As an example, the system can generate one or more additional forward segments for each of one or more forward update iterations. In particular, the system can generate, using the video generation neural network and conditioned on a previously generated forward segment, a respective additional forward segment of the video at each forward update iteration. For example, the additional forward segment can include X video frames immediately following the previously generated forward segment.

Likewise, as another example, the system can generate one or more additional backward segments for each of one or more backward update iterations. In particular, the system can generate, using the video generation neural network and conditioned on a previously generated backward segment, a respective additional backward segment of the video at each backward update iteration. For example, the additional backward segment can include Y video frames immediately prior to the previously generated backward segment.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining a reference video frame;
generating, using a video generation neural network and conditioned on the reference video frame, a first forward segment of the video, wherein the first forward segment comprises a first number of video frames immediately following the reference video frame in the sequence of video frames;
generating, using the video generation neural network and conditioned on the reference video frame, a first backward segment of the video, wherein the first backward segment comprises a second number of video frames immediately prior to the reference video frame in the sequence of video frames; and
generating a first video output for inclusion in the video from the first forward segment of the video and the first backward segment of video.

Embodiment 2 is the method of embodiment 1, further comprising:
for each of one or more forward update iterations:
   generating, using the video generation neural network and conditioned on a previously generated forward segment, a respective additional forward segment of the video that comprises a third number of video frames immediately following the previously generated forward segment; and
   generating the video from the first video output and the one or more additional forward segments of the video.

Embodiment 3 is the method of any one of embodiments 1-2, further comprising:
for each of one or more backward update iterations:
   generating, using the video generation neural network and conditioned on a previously generated backward segment, an additional backward segment of the video that comprises a fourth number of video frames immediately prior to the previously generated backward segment; and
generating the video from the first video output and the one or more additional backward segments of the video.

Embodiment 4 is the method of any one of embodiments 1-3, wherein obtaining the reference video frame comprises:
receiving a text prompt; and
generating the reference video frame by processing the text prompt using a text-to-image machine learning model.

Embodiment 5 is the method of any one of embodiments 1-4, wherein each video frame in the sequence of video frames is associated with a respective time step in a temporal ordering, and wherein generating the first video output from the first forward segment of the video and the first backward segment of video comprises:
combining the video frames of the first backward segment and the first forward segment according to the temporal ordering of the time steps within the video.

Embodiment 6 is the method of any one of embodiments 1-5, wherein the first video output has a first spatial resolution, and wherein the method further comprises generating a second output video that has a second higher spatial resolution using the reference video frame and each of the video frames of the first video output.

Embodiment 7 is the method of embodiment 6, wherein each video frame in the sequence of video frames is associated with a respective time step in a temporal ordering, and wherein generating the second output video that has a second higher resolution using the reference video frame and each of the video frames of the first video output comprises:
processing, from the reference video frame to a first video frame of the first backward segment according to the temporal order, using a spatial super-resolution model, to generate super-resolution video frames for the first backward segment; and
processing, from the reference video frame to a last video frame of the first forward segment according to the temporal order, using the spatial super-resolution model to generate super-resolution video frames for the forward segment.

Embodiment 8 is the method of any one of embodiments 1-7, wherein the first number of video frames and the second number of video frames are equivalent.

Embodiment 9 is the method of any one of embodiments 1-8, wherein generating the first forward segment of the video using the video generation neural network comprises generating the first forward segment of the video using the video generation neural network with a first set of parameter values.

Embodiment 10 is the method of any one of embodiments 1-9, wherein generating the first backward segment of the video using the video generation neural network comprises generating the first backward segment of the video using the video generation neural network with a second set of parameter values.

Embodiment 11 is the method of embodiment 10, wherein the second set of parameter values have been finetuned for backward video generation on a dataset comprising reversed video extension data.

Embodiment 12 is the method of embodiment 10, wherein the second set of parameter values have been finetuned for backward video generation on a dataset comprising reversed video animation data.

Embodiment 13 is method of embodiment 10, wherein the second set of parameter values comprises a first set of parameter values of the video generation neural network and parameter values from one or more low-rank adaptation layers.

Embodiment 14 is the method of any one of embodiments 1-13, wherein the video generation neural network is an auto-regressive neural network that generates each video frame conditioned on one or more previously generated video frames according to a temporal ordering of the sequence of one or more video frames in the video.

Embodiment 15 is the method of embodiment 14, wherein generating the first forward segment of the first video output comprises generating each video frame in the first forward segment by conditioning the video generation neural network on the reference video frame and any already-generated video frames within the first forward segment that precede the video frame in the temporal ordering.

Embodiment 16 is the method of any one of embodiments 14-15, wherein generating the first backward segment of the first video output comprises generating each video frame in the first backward segment by conditioning the video generation neural network on the reference video frame and any already-generated video frames within the first backward segment that follow the video frame in the temporal ordering.

Embodiment 17 is the method of any one of embodiments 1-16, wherein the reference video frame is not included in the first video output.

Embodiment 18 is a system comprising: one or more computers and one or more storage devices storing instructions that are operable, when executed by the one or more computers, to cause the one or more computers to perform the method of any one of embodiments 1 to 17.

Embodiment 19 is a computer storage medium encoded with a computer program, the program comprising instructions that are operable, when executed by data processing apparatus, to cause the data processing apparatus to perform the method of any one of embodiments 1 to 17.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for generating a video comprising a sequence of video frames, the method comprising:
obtaining a reference video frame;
generating, using a video generation neural network and conditioned on the reference video frame, a first forward segment of the video, wherein the first forward segment comprises a first number of video frames immediately following the reference video frame in the sequence of video frames;
generating, using the video generation neural network and conditioned on the reference video frame, a first backward segment of the video, wherein the first backward segment comprises a second number of video frames immediately prior to the reference video frame in the sequence of video frames; and
generating a first video output for inclusion in the video from the first forward segment of the video and the first backward segment of video.

2. The method of claim 1, further comprising:
for each of one or more forward update iterations:
generating, using the video generation neural network and conditioned on a previously generated forward segment, a respective additional forward segment of the video that comprises a third number of video frames immediately following the previously generated forward segment; and
generating the video from the first video output and the one or more additional forward segments of the video.

3. The method of claim 1, further comprising:
for each of one or more backward update iterations:
generating, using the video generation neural network and conditioned on a previously generated backward segment, an additional backward segment of the video that comprises a fourth number of video frames immediately prior to the previously generated backward segment; and
generating the video from the first video output and the one or more additional backward segments of the video.

4. The method of claim 1, wherein obtaining the reference video frame comprises:
receiving a text prompt; and
generating the reference video frame by processing the text prompt using a text-to-image machine learning model.

5. The method of claim 1, wherein each video frame in the sequence of video frames is associated with a respective time step in a temporal ordering, and wherein generating the first video output from the first forward segment of the video and the first backward segment of video comprises:
combining the video frames of the first backward segment and the first forward segment according to the temporal ordering of the time steps within the video.

6. The method of claim 1, wherein the first video output has a first spatial resolution, and wherein the method further comprises generating a second output video that has a second higher spatial resolution using the reference video frame and each of the video frames of the first video output.

7. The method of claim 6, wherein each video frame in the sequence of video frames is associated with a respective time step in a temporal ordering, and wherein generating the second output video that has a second higher resolution using the reference video frame and each of the video frames of the first video output comprises:
processing, from the reference video frame to a first video frame of the first backward segment according to the temporal order, using a spatial super-resolution model, to generate super-resolution video frames for the first backward segment; and
processing, from the reference video frame to a last video frame of the first forward segment according to the temporal order, using the spatial super-resolution model to generate super-resolution video frames for the forward segment.

8. The method of claim 1, wherein the first number of video frames and the second number of video frames are equivalent.

9. The method of claim 1, wherein generating the first forward segment of the video using the video generation neural network comprises generating the first forward segment of the video using the video generation neural network with a first set of parameter values.

10. The method of claim 1, wherein generating the first backward segment of the video using the video generation neural network comprises generating the first backward segment of the video using the video generation neural network with a second set of parameter values.

11. The method of claim 10, wherein the second set of parameter values have been finetuned for backward video generation on a dataset comprising reversed video extension data.

12. The method of claim 10, wherein the second set of parameter values have been finetuned for backward video generation on a dataset comprising reversed video animation data.

13. The method of claim 10, wherein the second set of parameter values comprises a first set of parameter values of the video generation neural network and parameter values from one or more low-rank adaptation layers.

14. The method of claim 1, wherein the video generation neural network is an auto-regressive neural network that generates each video frame conditioned on one or more previously generated video frames according to a temporal ordering of the sequence of one or more video frames in the video.

15. The method of claim 14, wherein generating the first forward segment of the first video output comprises generating each video frame in the first forward segment by conditioning the video generation neural network on the reference video frame and any already-generated video frames within the first forward segment that precede the video frame in the temporal ordering.

16. The method of claim 14, wherein generating the first backward segment of the first video output comprises generating each video frame in the first backward segment by conditioning the video generation neural network on the reference video frame and any already-generated video frames within the first backward segment that follow the video frame in the temporal ordering.

17. The method of claim 1, wherein the reference video frame is not included in the first video output.

18. A system comprising one or more computers and one or more storage devices storing instructions that are operable, when executed by the one or more computers, to cause the one or more computers to perform operations comprising:
obtaining a reference video frame;
generating, using a video generation neural network and conditioned on the reference video frame, a first forward segment of the video, wherein the first forward segment comprises a first number of video frames immediately following the reference video frame in the sequence of video frames;
generating, using the video generation neural network and conditioned on the reference video frame, a first backward segment of the video, wherein the first backward segment comprises a second number of video frames immediately prior to the reference video frame in the sequence of video frames; and
generating a first video output for inclusion in the video from the first forward segment of the video and the first backward segment of video.

19. The system of claim 18, further comprising:
for each of one or more backward update iterations:
generating, using the video generation neural network and conditioned on a previously generated backward segment, an additional backward segment of the video that comprises a fourth number of video frames immediately prior to the previously generated backward segment; and
generating the video from the first video output and the one or more additional backward segments of the video.

20. A computer storage medium encoded with a computer program, the program comprising instructions that are operable, when executed by data processing apparatus, to cause the data processing apparatus to perform operations comprising:
obtaining a reference video frame;
generating, using a video generation neural network and conditioned on the reference video frame, a first forward segment of the video, wherein the first forward segment comprises a first number of video frames immediately following the reference video frame in the sequence of video frames;
generating, using the video generation neural network and conditioned on the reference video frame, a first backward segment of the video, wherein the first backward segment comprises a second number of video frames immediately prior to the reference video frame in the sequence of video frames; and
generating a first video output for inclusion in the video from the first forward segment of the video and the first backward segment of video.
